(19) United States
(12) Patent Application Publication
(10) Pub. No.: US 2026/0134565 A1
(43) Pub. Date: May 14, 2026

(54) METHOD AND APPARATUS FOR PROVIDING 6DoF HEAD POSE ESTIMATION FROM MONOCULAR VIDEO

(71) Applicants: ELECTRONICS AND TELECOMMUNICATIONS RESEARCH INSTITUTE, Daejeon (KR); KWANGWOON UNIVERSITY INDUSTRY-ACADEMIC COLLABORATION FOUNDATION, Seoul (KR)

(72) Inventors: Young Hee KIM, Daejeon (KR); Ju Yong CHANG, Seoul (KR); Sung Ho CHUN, Seoul (KR)

(21) Appl. No.: 19/254,563

(22) Filed: Jun. 30, 2025

(30) Foreign Application Priority Data
Nov. 12, 2024 (KR) 10-2024-0159915

(51) Int. Cl. G06T 7/70; G06F 3/0346; G06V 10/771; G06V 40/16

(52) U.S. Cl. CPC G06T 7/70; G06F 3/0346; G06V 10/771; G06V 40/171; G06T 2207/30201

(57) ABSTRACT

A method and an apparatus for providing 6DoF head pose estimation from a monocular video by the present disclosure which provides a computer-implemented method for estimating a 6DoF head pose from a monocular video, comprising: extracting a feature map from the monocular video; performing sampling, based on the feature map and a sample point which is a coordinate set aligned to estimate a 3D facial landmark, and thereafter, calculating a 5D landmark-aligned feature vector by a first multi-layer perceptron; and estimating each of a 3D facial landmark coordinate vector, a 6D head rotation vector, and a 3D head translation vector, which are face structural feature point sets, based on the 5D landmark-aligned feature vector.

### CROSS-REFERENCE TO RELATED APPLICATION

The present application claims the benefit of and priority to Korean Patent Application No. 10-2024-0159915, filed on Nov. 12, 2024, the entire disclosure of which is hereby incorporated herein by reference in its entirety.

### TECHNICAL FIELD

The present disclosure relates to a method and an apparatus for providing 6DoF head pose estimation from a monocular video.

### BACKGROUND

The statements in this section merely provide background information related to the present disclosure and do not necessarily constitute prior art.

6DoF (six degrees of freedom) head pose estimation is an important research topic in computer vision, and can be utilized in various applications such as augmented reality (AR), a driver monitoring system, and a sports analysis. However, current major researches focus on head rotation estimation, and do relatively less deal with head translation estimation. The related art for head pose estimation can be divided into a landmark-free method and a landmark-based method.

The landmark-free method is a method for directly estimating a head pose by using only an image input without using facial shape information. For example, an ‘img2pose’ model estimates not only head rotation but also head translation. However, the model has a difficulty in accurately estimating the head pose, since internal camera parameters are not used in calculating the head translation. In addition, according to the landmark-free approaching method, a depth is directly estimated from an image. Therefore, strong nonlinearity appears, and it is difficult to estimate the head translation. Furthermore, since the facial shape information is not utilized in an inference process, depth ambiguity can deteriorate.

The landmark-based method is a method for estimating a 6DoF head pose or 3D head rotation by using the facial shape information. According to the landmark-based approaching method, an interaction between a facial landmark and head rotation is utilized to enable accurate estimation. For example, a ‘SynergyNet’ model simultaneously estimates a 2D facial landmark and the 3D head rotation by using a learning-based approaching method. However, the landmark-based method does not consider a mutually complementary relationship between 3D facial shape information and head translation.

According to optimization-based methods in the related art, a facial landmark is first estimated from an image, and thereafter, a one-way information transfer method for calculating a head pose is used by using the landmark. However, the landmark-based method has a difficulty in accurately estimating a face size due to the absence of depth information. Therefore, estimating the face size becomes unclear, and accuracy in estimating the head translation estimation is degraded.

### SUMMARY

An object of the present disclosure is to provide a method and an apparatus for providing 6DoF head pose estimation from a monocular video.

Specifically, the present disclosure addresses a task of estimating a head translation which has been relatively less studied compared to a head rotation in estimating a head pose. In this manner, the present disclosure improves accuracy in estimating the head pose by utilizing a mutually complementary relationship between the head translation and a 3D facial landmark.

The technical objects of the present disclosure are not limited to those described above, and other technical objects not mentioned above may be understood clearly by those skilled in the art from the descriptions given below.

According to at least one aspect, the present disclosure provides a computer-implemented method for estimating a 6DoF head pose from a monocular video, comprising: extracting a feature map from the monocular video; performing sampling, based on the feature map and a sample point which is a coordinate set aligned to estimate a 3D facial landmark, and thereafter, calculating a 5D landmark-aligned feature vector by a first multi-layer perceptron; and estimating each of a 3D facial landmark coordinate vector, a 6D head rotation vector, and a 3D head translation vector, which are face structural feature point sets, based on the 5D landmark-aligned feature vector.

According to at least one aspect, the present disclosure provides an apparatus for performing 6DoF head pose estimation from a monocular video, the apparatus comprising: at least one memory storing commands; and at least one processor, wherein the at least one processor executes the commands to perform: extracting a feature map from the monocular video; performing sampling, based on the feature map and a sample point which is a coordinate set aligned to estimate a 3D facial landmark, and thereafter, calculating a 5D landmark-aligned feature vector by a first multi-layer perceptron; and estimating each of a 3D facial landmark coordinate vector, a 6D head rotation vector, and a 3D head translation vector, which are face structural feature point sets, based on the 5D landmark-aligned feature vector.

According to one embodiment of the present disclosure, facial shape information (3D facial landmark) and pose information (head rotation and a head position) may be simultaneously estimated from a monocular video, and the facial shape information and the pose information may be mutually complementarily utilized to improve accuracy in estimating a head pose.

According to one embodiment of the present disclosure, correction using bounding box information is performed to improve accuracy in estimating the head position and to improve accuracy in estimating the head pose. The technical effects of the present disclosure are not limited to the technical effects described above, and other technical effects not mentioned herein may be understood to those skilled in the art to which the present disclosure belongs from the description below.

The effects of the present disclosure are not limited to those mentioned above, and other effects not mentioned will be apparent to those of ordinary skill in the art from the above description.

### BRIEF DESCRIPTION OF THE DRAWINGS

FIG. 1 a block diagram of an apparatus for performing head pose estimation according to one embodiment of the present disclosure.

FIG. 2 is a block diagram illustrating a detailed configuration of a face estimation module according to an embodiment of the present disclosure.

FIG. 3 is a flow diagram illustrating a method for performing head pose estimation according to one embodiment of the present disclosure.

FIG. 4 is a block diagram illustrating an exemplary computing device that can be used to implement the apparatus and the method according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

In the present disclosure, the term ‘image’ may be used interchangeably with the term ‘video’. In a technical context, the video and the image are mutually different concepts, but in a field of computer vision, the two terms are sometimes used interchangeably depending on specific circumstances.

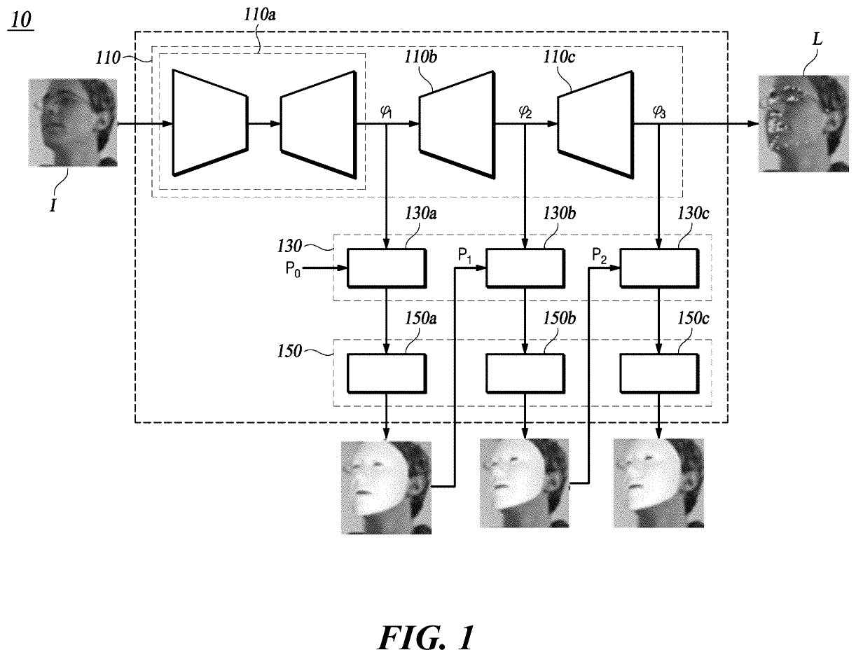

FIG. 1 a block diagram of an apparatus for performing head pose estimation according to one embodiment of the present disclosure.

A head pose estimation apparatus 10 is an apparatus for performing the 6DoF head pose estimation from the monocular video in which a person's head is imaged at a single viewpoint. The head pose estimation apparatus 10 simultaneously estimates a head pose (head rotation and head position) and a 3D facial landmark, and in this process, two information on the head pose and the 3D facial landmark are designed to repeatedly improve each other.

A 6DoF refers to all possible directions in which an object is movable in a three-dimensional space. The 6DoF is divided into three translations and three rotations. The translation includes a rightward-leftward direction (X-axis translation), an upward-downward direction (Y-axis translation), and forward-rearward direction (Z-axis translation). The rotation includes a rotation in which an object tilts forward and rearward (X-axis rotation, roll), a rotation in which an object tilts rightward and leftward (Y-axis rotation, pitch), and a rotation in which an object changes a direction rightward and leftward (Z-axis rotation, yaw).

The 3D facial landmark refers to 3D facial coordinates defined in a head space. The head space refers to a coordinate system attached to a central portion of a face and moving together with a rotation and a movement of a head. As an example, the 3D facial landmark can be expressed as a set of structural feature points of the face expressed as a 3D coordinate vector. A position of the head according to the head rotation and the head movement refers to a rotation and a translation which transform the 3D facial landmark defined in the head space into a camera coordinate system. As an example, the head rotation can be expressed as a 6D rotation vector, and head position can be expressed as a 3D translation vector.

Referring to FIG. 1, the head pose estimation apparatus 10 may include all or a part of a feature extraction block 110, a feature sampling block 130, and a face regression block 150. All blocks illustrated in FIG. 1 are not essential configuration elements, and some blocks included in other embodiments may be added, changed, or deleted. Meanwhile, the configuration elements illustrated in FIG. 1 represent functionally distinct elements, and at least one of the configuration elements may be implemented in a form in which the configuration elements are integrated with each other in an actual physical environment.

The feature extraction block 110 according to one embodiment of the present disclosure may include feature extraction modules 1 to 3 (110a, 110b, and 110c).

The feature extraction module 1 (110a) may fulfill a function of extracting a feature map having a lowest resolution from an input image I. The feature extraction module 1 (110a) may include ResNet18 which is one of CNN models, and a deconvolution layer. As an example, the feature extraction module included in the feature extraction block 110 may utilize a multi-scale convolutional neural network. As another example, since the present disclosure does not perform a task related to classification, the ResNet18 may be used by removing a fully connected layer. In order to maintain a resolution of the feature map, the ResNet18 may be used after removing a pooling layer. A feature map φ₁ generated from the feature extraction module 1 (110a) may be transmitted to the feature sample module 1 (130a).

The feature extraction module 2 (110b) may extract information on a deeper layer by using a low-resolution feature map generated from feature extraction module 1 (110a). The feature extraction module 2 (110b) may increase the resolution of the feature map by using the deconvolution layer. A feature map φ₂ generated from feature extraction module 2 (110b) May be transmitted to the feature sample module 2 (130b).

The feature extraction module 3 (110c) is a process of generating the feature map having a highest resolution, and may apply 1×1 convolution and soft-argmax operation to the feature map generated from the feature extraction module 2 (110b) to generate a 2D heatmap used for final landmark estimation and head pose estimation. A feature map generated from the feature extraction module 3 (110c) may be transmitted to the feature sample module 3 (130c).

For example, the feature extraction block 110 may calculate a feature map

$${\{ {Φ}_{t} \}}_{t = 1}^{3}$$

and a 2D sparse landmark L∈R^{2×N}^{^{L}} from a single image I. Here, N^{L} represents the number of sparse landmarks. The feature extraction block 110 may include the ResNet18, three deconvolution layers, the 1×1 convolution layer, and a soft-argmax layer. The ResNet18 is initialized with a weight pre-trained on an ImageNet, and may be used after removing the fully connected layer and the pooling layer. A feature map φₜ is calculated from a t^{-th} deconvolution layer, and is transmitted to a feature sampling block. In one embodiment, the final feature map φ₃ may be converted into the 2D heatmap by the 1×1 convolution layer. The soft-argmax layer calculates L from the heatmap. The calculated landmark may be included in a loss function along with a correct landmark L*∈R^{2×N}^{^{L}} The feature sampling block 130 may perform a function of extracting feature vectors aligned to the landmark from the feature maps (φ₁, φ₂, φ₃) generated by the feature extraction block.

The feature sampling block 130 according to one embodiment of the present disclosure may include feature sample modules 1 to 3 (130a, 130b, and 130c). Each of the feature sample modules extracts a feature vector located at a sample point from the feature map generated in a previous stage. Each of the feature sample modules provides the face regression block 150 with data required for calculating a head pose and a landmark position, based on the extracted feature. As an example, the feature sampling block 130 may extract a unit feature vector per sample point by using a bilinear sampling method. The point unit feature vector may be converted into a landmark-aligned feature vector by using a multi-layer perceptron [symbol] (·) The multi-layer perceptron [symbol] (·) may include three linear layers and two Leaky ReLU layers.

The feature sample module 1 (130a) extracts the feature vector, based on an initial sample point p₀ in the first feature map φ₁ For example, the initial sample point p₀ may be set as a 2D grid point coordinate. The feature sample module 1 (130a) may collect spatial information in the image I. The feature sample module 2 (130b) may extract a point-by-point feature, based on a sample point p₁ in the second feature map φ₂. The feature sample module 2 (130b) may collect information on a deeper layer to complement information obtained from the feature sample module 1 (130a). The feature sample module 3 (130c) may extract a high-resolution feature vector aligned to the landmark, based on the sample point p₂ from the third feature map φ₃. The sample points P₁, P₂ are calculated by the perspective projection module 260.

For example, the feature sampling block 130 calculates a feature vector

$${ϕ}_{t}^{{P}_{t}} ∈ {R}^{5 \times {N}_{t - 1}^{P}}$$

aligned to the landmark from the feature map φₜ and a sample point

$${P}_{t - 1} ∈ {R}^{2 \times }$$

which is a feature point coordinate set aligned for 3D landmark estimation. A sample point Pₜ₋₁ is used to extract a point-by-point feature from a feature map φₜ Here, P₀ may be a 2D grid coordinate, and in a case of t>0, Pₜ is calculated by the t^{-th} face regression block 150. A point-by-point feature vector φₜ (Pₜ₋₁, n)∈R²⁵⁶ may be acquired by using a bilinear sampling method at a location designated as a point Pₜ₋₁, n∈R² in the feature map φₜ A point Pₜ₋₁, n represents a n-th column vector of a sample point Pₜ₋₁ As expressed in Mathematic Expression 1, a point-by-point feature

$${{Φ}_{t} ( {P}_{t - 1} , n )}_{n = 1}^{{N}_{t - 1}^{P}}$$

may be transformed into a 5-dimensional vector by using a dimensionality reduction layer [symbol] (·) The transformed 5-dimensional vectors may be concatenated to form a feature vector

$${ϕ}_{t}^{{P}_{t}}$$

aligned to the landmark later. The transformed 5-dimensional vectors are transmitted to the face regression block.

$${ϕ}_{t}^{{P}_{t}} = {{⊕}_{n = 1}}^{{N}_{t - 1}^{P}} ℱ ( {ϕ}_{t} ( {p}_{t - 1 , n} ) ) \qquad [ Mathematic Expression 1 ]$$

The face regression block 150 may be operated by receiving an input of the feature vector extracted by the feature sampling block 130 and gradually improving the head pose and the landmark.

The face regression block 150 according to one embodiment of the present disclosure may include a face estimation module 1 to a face estimation module 3 (150a, 150b, and 150c).

The face estimation module 1 (150a) estimates initial head rotation and translation, and the 3D landmark from the feature vector input in the first stage. For example, the face estimation module 1 (150a) may perform first estimation by calculating the residual by performing the regression by using the multi-layer perceptron, based on the landmark-aligned feature vector. As another example, the face estimation module 2 (150b) may perform an additional correction, based on an output of the face estimation module 1 (150a), may calculate the residual of the head rotation and translation, and may improve accuracy by adding the calculated result to a previous value. As another example, the face estimation module 2 (150b) may improve the accuracy of the head translation by utilizing the bounding box information.

The bounding box represents a rectangular region including a specific object (for example, a face) inside an image. The bounding box is used to define a location and a size of an object on an image, and is generally used in object recognition or tracking. The correction of the bounding box is a process of more accurately adjusting the location and the size of the bounding box, and is a process of correcting an error between an actual location of the object (for example, a face) and the bounding box and correcting the bounding box so that the bounding box may more accurately include the center of the object.

The face estimation module 3 (150c) may estimate the head rotation and translation, and the 3D landmark by performing final correction.

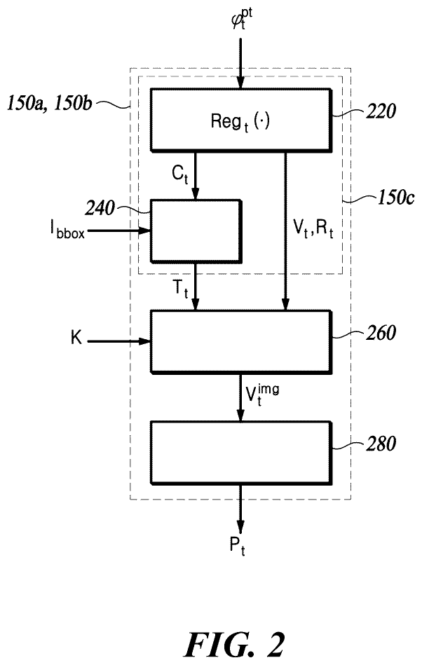

FIG. 2 is a block diagram illustrating a detailed configuration of the face estimation module according to an embodiment of the present disclosure.

Referring to FIG. 2, the face estimation modules 150a, 150b, and 150c may include all or a part of a face regression module 220, a translation calculation module 240, a perspective projection module 260, and a subsample module 280. All blocks illustrated in FIG. 2 are not essential configuration elements, and some blocks included in other embodiments may be added, changed, or deleted. Meanwhile, the configuration elements illustrated in FIG. 2 represent functionally distinct elements, and at least one of the configuration elements may be implemented in a form in which the configuration elements are integrated with each other in an actual physical environment.

The face regression module 220 processes a specific input by using a structure such as the multi-layer perceptron (MLP). For example, the face regression module 220 may include a bounding box correction parameter, and a function Regₜ for calculating the 3D facial landmark. t represents the stage number at which the estimation is repeated. Rₜ∈R⁶ is a head rotation vector, and represents the rotation (roll, pitch, and yaw) of the head in a 6-dimensional space. Cₜ∈ [symbol] is a bounding box correction parameter, and represents a scale and an offset between the center of the head and the center of the bounding box. Vₜ∈R^{3×N}^{^{V}} is a landmark coordinate, and includes the 3D coordinate for the landmark.

The translation calculation module 240 may include a function for calculating a head translation

$${T}_{t} = \{ {T}_{x}^{t} , {T}_{y}^{t} , {T}_{z}^{t} \} ∈ {R}^{3} ,$$

based on bounding box information

$${I}_{bbox} = \{ {τ}_{x}^{bbox} , {τ}_{y}^{bbox} , b , f \}$$

and bounding box correction parameter Cₜ. Here,

$${τ}_{x}^{bbox} , {τ}_{y}^{bbox}$$

represents x and y coordinates of the bounding box, and represents center coordinates of the bounding box of an uncropped original image, in which b represents a size of the bounding box, and f represents a focal length of a camera.

$$\{ {T}_{x}^{t} , {T}_{y}^{t} , {T}_{z}^{t} \} ∈ {R}^{3}$$

is a 3D vector representing the head translation in a stage t, and represents the head translation along x, y, and z axes. The calculation of Tₜ is expressed as Mathematical Expression 2 by using correction parameters Cₜ and I_{bbox}.

$$[ Mathematic Expression 2 ]$$

$${T}_{x}^{t} = \frac{0.2 {s}_{t}}{b} {τ}_{x}^{bbox} + 0.2 {s}_{t} {τ}_{x}^{face} , {T}_{y}^{t} = \frac{0.2 {s}_{t}}{b} {τ}_{y}^{bbox} + 0.2 {s}_{t} {τ}_{y}^{face} , {T}_{z}^{t} = \frac{0.2 {s}_{t}}{b} f$$

For example, a real human face may be modeled as being included in a box B having a size of 0.2 meters. The size of the box in an image space is expressed by b. However, since the size of the face is not constant, Regₜ( ) estimates a scale factor to adjust the size of the box. In addition, Regₜ( ) determines normalized offsets

$${τ}_{x}^{face} , {τ}_{y}^{face}$$

between a head center and a bounding box center. This offset represents a value obtained by normalizing image space transformation from the bounding box center to the head center.

The perspective projection module 260 may fulfill a function of projecting a 3D landmark coordinate Vₜ into a 2D image space. The perspective projection is performed by using a basic parameter K of the camera, and maybe expressed as in Mathematical Expression 3.

$${V}_{t}^{img} = ⊓ ( {V}_{t} , {R}_{t} , {T}_{t} , K ) \qquad [ Mathematic Expression 3 ]$$

Here, Π(·) represents a perspective projection function, and K∈R^{3×3} represents a basic camera parameter.

For example, when the camera parameter is not known, a sum of the width and the height of the uncropped original image may be used as the focal length, and center coordinates of the uncropped original image may be used as a principal point.

The subsample module 280 may acquire a sample point pₜ in the next stage by performing a subsampling process on a final projected 2D landmark coordinate

$${V}_{t}^{img} .$$

The sample point is used in the face regression module 220 in the next stage.

For example, the third face regression module 150c may not include either the perspective projection module 260 or the subsample module 280. The reason is as follows. The third face regression module 150c may not generate the sample point to be transmitted to subsequent stages by estimating the final head rotation, head position, and 3D face landmark. For example, the present disclosure may calculate the sample point, based on the estimated 3D face landmark, head rotation, and head position information, and may update a previously used sample point. In addition, the 3D face landmark, head rotation, and head position may be estimated again, based on the updated sample point, and the previous 3D face landmark, head rotation, and head position may be updated. As a result, accuracy in estimating the final 3D face landmark, head rotation, and head position may be improved by repeatedly performing the same stage. For example, although updating is performed twice in the present disclosure, the number of times of updating is not limited.

For example, the multi-layer perceptron Regₜ( ) may estimate the residual for calculating ⊖ₜ={Rₜ, Cₜ, Vₜ} from a feature vector

$${ϕ}_{t}^{{P}_{t}}$$

aligned to the landmark. The previously estimated output

$${⊖}_{t - 1}^{sub} = \{ {R}_{t - 1} , {c}_{t - 1} , {V}_{t - 1}^{sub} ∈ {R}^{3 \times 305} \}$$

and bounding box information I_{bbox} are also used as inputs to the face regression module 220. ⊖ₜ is calculated by adding the residual estimated by Regₜ to ⊖ₜ₋₁,

$${V}_{t - 1}^{sub}$$

is a landmark obtained by subsampling Vₜ₋₁. In order to improve model performance, redundancy of the calculation may be reduced by using the subsampled

$${V}_{t - 1}^{sub}$$

instead of Vₜ₋₁. For example, in order to reduce the redundancy of the calculation, only ¼ of the number N^{V} of facial landmarks may be subsampled and used as the sample point.

For example, in a case of the face estimation module 150a, any one of the 3D face landmark, the head rotation, and the head position which are estimated in the previous stage does not exist. Therefore, a 3D face landmark 0(V₀), a head rotation 0(R₀), and a head position 0(C₀, T₀) which are defined in advance are used. The 3D face landmark 0, the head rotation 0, and the head position 0 may be defined in any desired way.

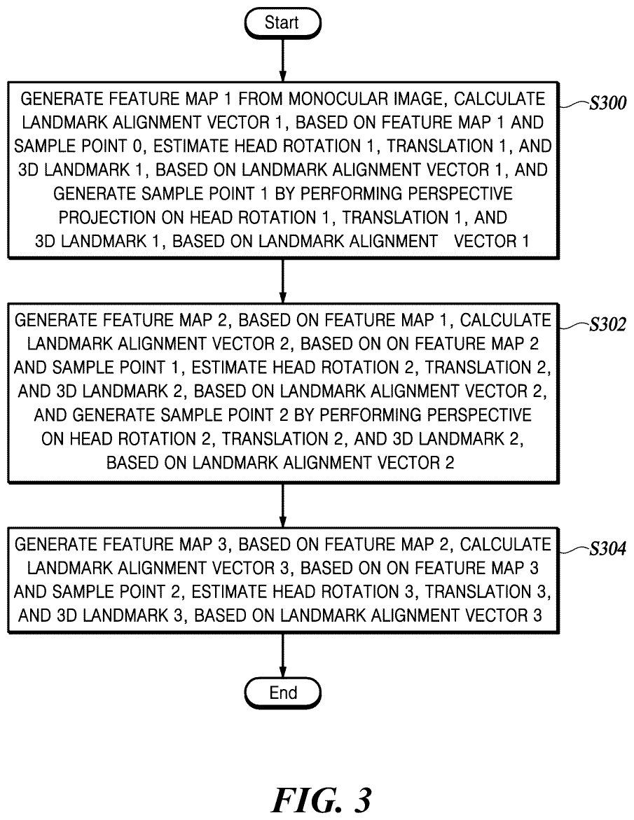

FIG. 3 is a flowchart schematically illustrating a method for performing the head pose estimation according to one embodiment of the present disclosure.

The head pose estimation apparatus 10 may receive an input of the monocular video, and may generate the feature map 1 φ₁ from the feature extraction module 1 (110a). For example, the feature extraction module 1 (110a) may include the ResNet18 and the deconvolution layer from which the pooling layer and the fully connected layer removed. The generated feature map 1 φ₁ may be transmitted to the feature sample module 1 (130a) to calculate a landmark alignment vector

$$1 {ϕ}_{1}^{{p}_{1}} ,$$

based on the feature map 1 φ₁ and the sample point 0 p₀. For example, as the sampling, bilinear sampling may be performed. The face regression block 150 may receive an input of the calculated landmark alignment vector

$$1 {ϕ}_{1}^{{p}_{1}} ,$$

and may estimate a head rotation 1 R₁, a translation 1 T₁, and a 3D facial landmark 1 V₁ from the face estimation module 1 (150a). For example, in the estimation, the multi-layer perceptron may be used to predict the residual of the head rotation 1 R₁, the translation 1 T₁, and the 3D facial landmark 1 V₁. In this manner, calculation may be performed by adding the predicted residual to a head rotation 0 R₀, a head position 0 T₀, and a 3D facial landmark 0 V₀ which are defined in advance. The perspective projection module 260 may perform perspective projection on the estimated head rotation 1 R₁, translation 1 T₁, and 3D facial landmark 1 V₁, and may calculate the sample point 1 P₁ by using the subsample module 280. For example, the perspective projection is performed by using the parameter of the camera, and when the camera parameter is not known, a sum of a width and a height of an uncropped original image may be used as a focal length, and center coordinates of the uncropped original image may be used as a principal point. The calculated sample point 1 P₁ is used as the sample point in the next stage. For example, when only ¼ of the number N^{V} of the facial landmarks is subsampled and used as the sample point, redundancy in calculating the sampling may be reduced (S300).

The feature extraction module 2 (110b) may generate the feature map 2 φ₂. For example, the feature extraction module 2 (110b) may include the deconvolution layer. The generated feature map 2 φ₂ may be transmitted to the feature sample module 2 (130b) to calculate a landmark alignment vector

$$2 {ϕ}_{2}^{{p}_{2}} ,$$

based on the feature map 2 φ₂ and the sample point 1 P₁. For example, as the sampling, the bilinear sampling may be performed. The face regression block 150 may receive an input of the calculated landmark alignment vector

$$2 {ϕ}_{2}^{{p}_{2}} ,$$

and may estimate the head rotation R₂, the translation T₂, and the 3D facial landmark V₂ from the face estimation module 2 (150b). For example, in the estimation, the multi-layer perceptron may be used to predict the residual of the head rotation 2 R₂, the translation 2 T₂, and the 3D facial landmark 2 V₂ and the calculation may be performed by adding the predicted residual to the head rotation 1 R₁, the translation 1 T₁, and the 3D facial landmark 1 V₁ which are estimated in the previous stage. The perspective projection module 260 may perform the perspective projection on the estimated head rotation 2 R₂, translation 2 T₂, and 3D facial landmark 2 V₂ to calculate the sample point 2 P₂ by using the subsample module 280. For example, the perspective projection is performed by using the parameter of the camera, and when the camera parameter is not known, the sum of the width and the height of the uncropped original image may be used as the focal length, and the center coordinates of the uncropped original image may be used as the principal point. The calculated sample point 2 P₂ is used as the sample point in the next stage. For example, when only ¼ of the number N^{V} of facial landmarks is sampled and used as the sample point, redundancy in calculating the sampling may be reduced (S302).

The feature extraction module 3 (110c) may generate the feature map 3 φ₃. For example, the feature extraction module 3 (110c) may include the deconvolution layer. The generated feature map 3 φ₃ may be transmitted to the feature sample module 3 (130c) to calculate the landmark alignment vector

$$3 {ϕ}_{3}^{{p}_{3}} ,$$

based on the feature map 3 φ₃ and the sample point 2 P₂. For example, as the sampling, the bilinear sampling may be performed. The face regression block 150 may receive an input of the calculated landmark alignment vector

$$3 {ϕ}_{3}^{{p}_{3}} ,$$

and may estimate the head rotation R₃, the translation T₃, and the 3D facial landmark V₃ from the face estimation module 3 (150c). For example, in the estimation, the multi-layer perceptron may be used to predict the residual of head rotation 3 R₃, the translation 3 T₃, and the 3D facial landmark 3 V₃, and the calculation may be performed by adding the predicted residual to the head rotation 2 R₂, the translation 2 T₂, and the 3D facial landmark 2 V₂ which are estimated in the previous stage (S304).

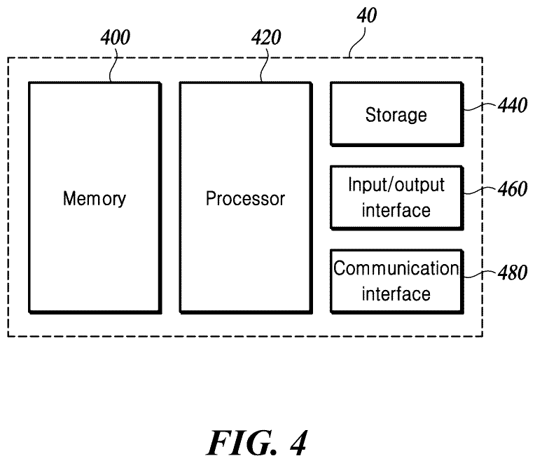

FIG. 4 is a block diagram illustrating an exemplary computing device that can be used to implement the apparatus and the method according to the present disclosure. A computing device 40 may include a part or all of a memory 400, a processor 420, a storage 440, n input/output interface 460, and a communication interface 480. The computing device 40 may be not only a stationary computing device such as a desktop computer and a server, but also a mobile computing device such as a laptop computer and a smartphone. The computing device 40 may include any specialized hardware accelerator capable of processing operations for an artificial intelligence model in an efficient manner. For example, the computing device 40 may include a graphic processing unit (GPU), a tensor processing unit (TPU), or a neural processing unit (NPU).

The memory 400 may store a program that causes the processor 420 to perform a method or an operation according to various embodiments of the present disclosure. For example, the program may include a plurality of commands executable by the processor 420, and the above-described method or operation may be performed by causing the processor 420 to execute the plurality of commands. The memory 400 may be a single memory or a plurality of memories. In this case, information required for performing the method or the operation according to various embodiments of the present disclosure may be stored in the single memory, or may be divided and stored in the plurality of memories. When the memory 400 includes the plurality of memories, the plurality of memories may be physically separated. The memory 400 may include at least one of a volatile memory and a nonvolatile memory. The volatile memory includes a static random access memory (SRAM) or a dynamic random access memory (DRAM), and the nonvolatile memory includes a flash memory.

The processor 420 may include at least one core capable of executing at least one command. The processor 420 may execute commands stored in the memory 400. The processor 420 may be a single processor or a plurality of processors.

The storage 440 maintains stored data even when power to be supplied to the computing device 40 is cut off. For example, the storage 440 may include a non-volatile memory, and may include storage media such as a magnetic tape, an optical disk, and a magnetic disk. A program stored in storage 440 may be loaded to the memory 400 before being executed by the processor 420. The storage 440 may store a file written in a program language, and a program generated from a file by a compiler or the like may be loaded to the memory 400. The storage 440 may store data to be processed by the processor 420 and/or data processed by the processor 420.

The input/output interface 460 may provide an interface with an input device such as a keyboard and a mouse and/or an output device such as a display device and a printer. A user may trigger execution of the program in the processor 420 through the input device and/or may check a processing result of the processor 420 through the output device.

The communication interface 480 may provide access to an external network. The computing device 40 may communicate with other devices via the communication interface 480.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents. Accordingly, one of ordinary skill would understand that the scope of the claimed invention is not to be limited by the above explicitly described embodiments but by the claims and equivalents thereof.

Accordingly, one of ordinary skill would understand that the scope of the claimed invention is not to be limited by the above explicitly described embodiments but by the claims and equivalents thereof.

What is claimed is:

1. A computer-implemented method for estimating a 6DoF head pose from a monocular video, comprising:
extracting a feature map from the monocular video;
performing sampling, based on the feature map and a sample point which is a coordinate set aligned to estimate a 3D facial landmark, and thereafter, calculating a 5D landmark-aligned feature vector by a first multi-layer perceptron; and
estimating each of a 3D facial landmark coordinate vector, a 6D head rotation vector, and a 3D head translation vector, which are face structural feature point sets, based on the 5D landmark-aligned feature vector.

2. The computer-implemented method of claim 1, further comprising:
extracting a feature map having a higher dimension than the feature map from the feature map, and updating the feature map;
performing perspective projection of the 3D facial landmark coordinate vector on a 2D image space, and reflecting the 6D head rotation vector and the 3D head translation vector information into the 2D image space to update the sample point;
performing the sampling, based on the updated feature map and the updated sample point, and updating the 5D landmark-aligned feature vector by the first multi-layer perceptron; and
updating the 3D facial landmark coordinate vector, the 6D head rotation vector, and the 3D head translation vector, based on the updated 5D landmark-aligned feature vector.

3. The computer-implemented method of claim 2, further comprising:
repeatedly performing the computer-implemented method one or more times to acquire finally updated 3D facial landmark coordinate vector, 6D head rotation vector, and 3D head translation vector.

4. The computer-implemented method of claim 2, wherein the extracting the feature map and the updating the feature map are performed by using a multi-scale convolutional neural network.

5. The computer-implemented method of claim 1, wherein the sampling includes extracting a point unit feature vector located at the sample point by performing bilinear sampling, based on the feature map, and calculating the feature vector aligned to the landmark, in which a dimension of the point unit feature vector is reduced by using the first multi-layer perceptron, the first multi-layer perceptron including three linear layers and two Leaky ReLU layers.

6. The computer-implemented method of claim 2, wherein the updating the 3D facial landmark coordinate vector, the 6D head rotation vector, and the 3D head translation vector includes calculating a residual for the 3D facial landmark coordinate vector, the 6D head rotation vector, and the 3D head translation vector by performing regression by using a second multi-layer perceptron, based on the updated sample point, and adding the residual to each of the 3D facial landmark coordinate vector, the 6D head rotation vector, and the 3D head translation vector.

7. The computer-implemented method of claim 2, further comprising:
subsampling the updated sample point.

8. The computer-implemented method of claim 2, wherein the perspective projection is performed by using camera's own parameters, and if the camera's own parameters are unknown, a sum of a width and a height of an uncropped original image is used as a focal length, and central coordinates of the uncropped original image are used as a principal point.

9. The computer-implemented method of claim 1, wherein the 3D head translation vector estimation is performed by calculating head translation, based on bounding box information and bounding box correction parameters.

10. The computer-implemented method of claim 4, wherein the multi-scale convolutional neural network is a neural network in which a full classification layer and a pooling layer are removed from a ResNet18-based artificial neural network.

11. An apparatus for performing 6DoF head pose estimation from a monocular video, the apparatus comprising:
at least one memory storing commands; and
at least one processor,
wherein the at least one processor executes the commands to perform:
extracting a feature map from the monocular video;
performing sampling, based on the feature map and a sample point which is a coordinate set aligned to estimate a 3D facial landmark, and thereafter, calculating a 5D landmark-aligned feature vector by a first multi-layer perceptron; and
estimating each of a 3D facial landmark coordinate vector, a 6D head rotation vector, and a 3D head translation vector, which are face structural feature point sets, based on the 5D landmark-aligned feature vector.

12. The apparatus of claim 11, further performing:
extracting a feature map having a higher dimension than the feature map from the feature map, and updating the feature map;
performing perspective projection of the 3D facial landmark coordinate vector on a 2D image space, and reflecting the 6D head rotation vector and the 3D head translation vector information into the 2D image space to update the sample point;
performing the sampling, based on the updated feature map and the updated sample point, and updating the 5D landmark-aligned feature vector by the first multi-layer perceptron; and
updating the 3D facial landmark coordinate vector, the 6D head rotation vector, and the 3D head translation vector, based on the updated 5D landmark-aligned feature vector.

13. The apparatus of claim 12, further performing repeatedly executing the commands one or more times to acquire finally updated 3D facial landmark coordinate vector, 6D head rotation vector, and 3D head translation vector.

14. The apparatus of claim 12, wherein the extracting the feature map and the updating the feature map are performed by using a multi-scale convolutional neural network.

15. The apparatus of claim 11, wherein the sampling includes extracting a point unit feature vector located at the sample point by performing bilinear sampling, based on the feature map, and calculating the feature vector aligned to the landmark, in which a dimension of the point unit feature vector is reduced by using the first multi-layer perceptron, the first multi-layer perceptron including three linear layers and two Leaky ReLU layers.

16. The apparatus of claim 12, wherein the updating the 3D facial landmark coordinate vector, the 6D head rotation vector, and the 3D head translation vector includes calculating a residual for the 3D facial landmark coordinate vector, the 6D head rotation vector, and the 3D head translation vector by performing regression by using a second multi-layer perceptron, based on the updated sample point, and adding the residual to each of the 3D facial landmark coordinate vector, the 6D head rotation vector, and the 3D head translation vector.

17. The apparatus of claim 12, wherein further performing subsampling the updated sample point.

18. The apparatus of claim 12, wherein the perspective projection is performed by using camera's own parameters, and if the camera's own parameters are unknown, a sum of a width and a height of an uncropped original image is used as a focal length, and central coordinates of the uncropped original image are used as a principal point.

19. The apparatus of claim 11, wherein the 3D head translation vector estimation is performed by calculating head translation, based on bounding box information and bounding box correction parameters.

20. The apparatus of claim 14, wherein the multi-scale convolutional neural network is a neural network in which a full classification layer and a pooling layer are removed from a ResNet18-based artificial neural network.
